(19) United States
(12) Patent Application Publication
(10) Pub. No.: US 2016/0156889 A1
(43) Pub. Date: Jun. 2, 2016

(54) CONTROL SYSTEM AND METHOD FOR A DEVICE FOR GENERATING SCANNED IMAGES, IMAGE GENERATING DEVICE AND DISPLAY INCLUDING SUCH A SYSTEM

(71) Applicant: VALEO COMFORT AND DRIVING ASSISTANCE, Créteil Cedex (FR)

(72) Inventor: Frédéric Autran, Créteil (FR)

(73) Assignee: VALEO COMFORT AND DRIVING ASSISTANCE, Creteil (FR)

(21) Appl. No.: 14/904,192

(22) PCT Filed: Jun. 30, 2014
(86) PCT No.: PCT/FR2014/000155

§ 371 Date: Jan. 11, 2016

(30) Foreign Application Priority Data
Jul. 12, 2013 (FR) 1301659

(51) Int. Cl. H04N 9/31; G02B 27/01

(52) U.S. Cl. CPC H04N 9/3185; H04N 9/3135; G02B 27/0101; G02B 2027/011; G02B 2027/014

(57) ABSTRACT

The invention relates to a control system (3) for a device (1) for generating scanned images, particularly for a display, specifically for a head up display. Said device is intended to form, from a light beam, an image (105) to be transmitted by an optical system (22). Said control system (3) includes a unit for generating scanning signals for causing a deviation of said beam such as to form said output image (105) from said image generation device (1), characterized in that said control system (3) is configured such that the scanning signals include a correction component enabling said image (105) to have a deformation that is the reverse of that produced by said optical system (22).

The invention relates to a control system and method for a device for generating scanned images. The invention relates also to an image generation device and a display, in particular a head-up display, intended to equip a motor vehicle, comprising such a control system.

It is known practice to equip a motor vehicle with a head-up display system.

Such a head-up system comprises, as is known, an image generation device, also called imager, which produces an image on a real support, and an optical system responsible for creating an image on a virtual support outside the vehicle in the field of view of the driver, from the image created on the real support. The scanned image generation device generally comprises a laser source, a horizontal and vertical scanning actuator, a mirror for deflecting laser beams driven by the actuator, and a semi-transparent screen on which the real image is formed. A control system makes it possible, from any video source, to modulate the laser beams in real time and drive, in synchronism, the horizontal and vertical scans of the actuator of the deflection mirror to obtain an image of the desired resolution and size.

The structure of the optical system, the practical constraints on its geometry and the fact that the freedom of action on the semi-reflecting surface is limited mean that the image produced by such a system undergoes significant nonlinear geometrical deformations (better known by the term anamorphism) which greatly degrade the image quality. This defect, commonly called “geometric image distortion”, has to be corrected by a compensation system. This defect becomes all the more of a nuisance when the image formats used are large. For example, the distortions become unacceptable for comfort in reading information projected for formats of 15°×3° type (the angle measurements relating to the apex angle in a triangle that has for its apex the eye of the user and for its base, respectively, the width and the height of the image). Furthermore, when the optical system comprises the windshield of the equipped vehicle rather than a semi-reflecting plate, which is particularly the case of high-end vehicles in order for all of the components of the display to remain hidden, the defect is accentuated because of the asymmetry originating from the off-center position of the projection system, the latter being in the axis of the driver, who is him- or herself off center relative to the axis of symmetry of the windshield.

Different compensation systems have been proposed. It is for example known practice to perform a real-time digital processing of the image by incorporating, in the video signal, a deformation that is the reverse of that produced by the optical system, by increasing the number of pixels in certain zones. However, this solution has weaknesses and limitations linked to the significant computing resources necessary for the computations and to the non-uniformity of the pixilation which results therefrom.

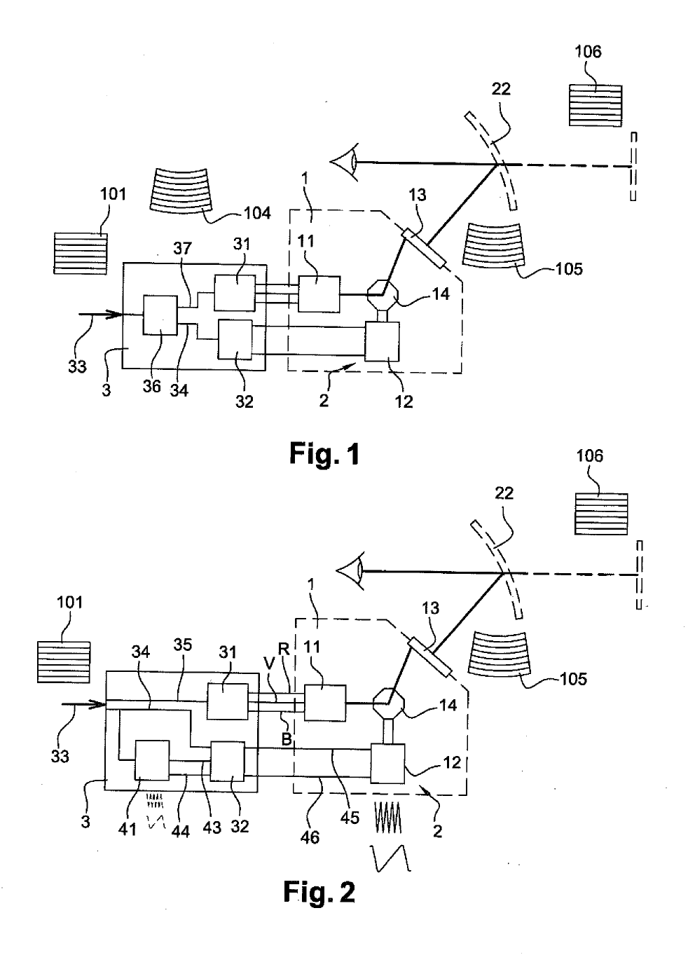

Such a solution is schematically represented in FIG. 1 which describes a head-up display, comprising an image generation device 1 and a control system 3 for said image generation device.

Said image generation device 1 comprises a light source 11, generating a light beam, a scanning generator 2 and a projection screen-forming surface 13. Said scanning generator allows said beam to scan said surface 13 so as to form the images projected by said display. Said control system 3 drives said scanning generator 2. The image to be projected 101 corresponds to a so-called initial video signal.

According to the correction solution described above, said control device first of all assesses the number and the position of the pixels to be added to said image 101, as a function of the geometrical distortion of the image to be corrected. It then computes a video signal the image 104 in which said pixels have been added to form a corrected image 104. Said video signal is sent to the image generation device which, conventionally, makes it possible to form the image 105 on the surface 13. Said image 105 corresponds to the corrected image 104. Said image 105 is in turn displayed according to the image 106, after transmission by the optical system of the display, here comprising the windshield 22. Said image 106 appears correctly since it includes, in reverse fashion, the deformations applied by said optical system.

That said, as indicated above, the main drawback of this method lies in the step of computation of the video signal corresponding to the corrected image 104.

Other solutions propose adding optical elements such as mirrors or lenses or else holographic compensations which require heavy image processing processes.

The invention aims to mitigate at least some of the abovementioned drawbacks.

To do this, the invention relates to a control system for a device for generating scanned images, notably for a display, in particular a head-up display, intended to form, from a light beam, an image to be transmitted by an optical system, said control system comprising a unit for generating scanning signals, intended to provoke a deflection of said beam so as to form said image, called output image of said image generation device.

According to the invention, said control system is configured for said scanning signals to include a correction component allowing said output image of said image generation device to exhibit a deformation that is the reverse of that produced by said optical system.

A control system according to the invention therefore makes it possible to generate corrected signals, from initial scanning signals, which compensate the geometrical deformations of the image introduced by the optical system to which the scanning image generation device is intended to be linked. In other words, the corrected signals lead to a deformation of the image produced by the scanning image generation device such that this image, once transmitted and deformed by the optical system, is restored to a non-deformed appearance. This compensation of deformation is produced without having recourse to the computation of an intermediate image with added pixels, which preserves the computing and electrical resources of the system. It is also produced without additional optical means.

Since the geometrical deformations of the image generated by an optical system are corrected, the image obtained exhibits a uniform pixilation.

Said system is configured to provoke, for example, a variation of a scanning speed making it possible to speed up or slow down the deflection of the beam at the necessary points to obtain said reverse deformation.

According to one embodiment of the invention, said scanning signal generation unit comprises a module for generating scanning signals, called initial signals, and a module for correcting said initial signals into signals, called corrected signals, suitable for provoking a deflection of said light beam so as to form said output image of said image generation device.

Advantageously, the corrected signals are determined from initial signals and predetermined correction functions.

The predetermined correction functions are independent of the content of the image and make it possible to supply corrected signals only from the initial scanning signals and predetermined parameters. No knowledge concerning the image is necessary.

The functions depend only on the optical system to which the scanned image generation device driven by the control system according to the invention is linked. In other words, the correction functions have to be parameterized by taking into account the use which is made of the control system according to the invention. For each optical system to which the control system of the scanned image generation device is intended to be linked, a parameterization of the correction functions has to be performed.

According to a variant of the invention, these functions are predetermined by reversing, by formal computation, the distortions of the image introduced by the optical system to which the scanned image generation device driven by the control system according to the invention is intended to be linked.

According to another advantageous variant of the invention, the predetermined correction functions are functions for approximating optical laws of distortion of an image by the optical system to which said scanned image generation device is intended to be linked.

These correction functions can be implemented by digital means or by analogue means or by a combination of digital and analogue means.

Advantageously, the module for generating initial signals comprises:
a module for extracting vertical and horizontal synchronization signals,
a module for generating an initial horizontal scanning signal,
a module for generating an initial vertical scanning signal.

The initial signals are therefore obtained from a video source and a module for extracting synchronization signals and modules for generating vertical and horizontal signals. According to this aspect of the invention, the scanned image generation device forms the image by a horizontal scan and a vertical scan, these scans being synchronized by the synchronization signals supplied by the module for extracting synchronization signals.

Advantageously, the module for correcting the scanning signals comprises a module for generating a modulation, notably of amplitude, of the initial horizontal scanning signal, that is a function of a vertical position in said image, synchronized by said vertical synchronization signal to supply a corrected horizontal scanning signal.

According to this aspect of the invention, the horizontal correction function supplies a horizontal position which depends on the horizontal and vertical position of the image before compensation and on its own correction parameters.

Advantageously, the module for correcting the scanning signals comprises a module for generating a modulation, notably of amplitude, of the initial vertical scanning signal, that is a function of a horizontal position in said image, synchronized by said horizontal synchronization signal to supply a corrected vertical scanning signal.

According to this aspect of the invention, the vertical correction function supplies a vertical position which depends on the horizontal and vertical position of the image before compensation and on its own correction parameters.

Said control system advantageously comprises a parameterizable non-volatile memory in which the correction functions are stored, notably in the form of tables or of parameterized formulae.

The invention relates also to an image generation device comprising a control system as described above.

According to different features of said image generation device which will be able to be taken together or separately:
said device comprises a scanning generator allowing said beam to scan a projection screen-forming surface of said device, said control system driving said scanning generator,
said projection screen is a diffuser,
said device comprises a light source generating said beam, notably of the laser type,
said light source is driven by said control system.

The invention relates also to a display, notably a head-up display, comprising an image generation device as described above. Said display comprises the optical system introducing the geometrical deformations of the image compensated by the control system.

In the case of a head-up display for a motor vehicle using an image generator with light source of the laser type, it should be noted that the invention makes it possible to have a solution whereby a non-deformed image is made available, without having to directly project the beam from the source onto the windshield.

The invention relates also to a control method for a device for generating scanned images intended to form, from a light beam, an image to be transmitted by an optical system, said method comprising a step of generation of scanning signals, intended to provoke a deflection of said beam so as to form said image, called output image of said image generation device, said scanning signals including a correction component allowing said output image of said image generation device to exhibit a deformation that is the reverse of that produced by said optical system.

A method according to the invention therefore makes it possible to correct control signals intended for a scanned image generation device for the image produced by this scanned image generation device to exhibit a deformation that is the reverse of the deformation produced by the optical system to which the scanned image generation device is intended to be linked. Thus, the resulting image at the output of the optical system no longer exhibits any optical deformation, the deformation generated by the optical system correcting the reverse deformation produced by the method according to the invention.

A variation of a scanning speed is for example provoked, making it possible to speed up or slow down the deflection of the beam at the necessary points to obtain said reverse deformation.

According to one embodiment of the invention, said scanning signal generation step comprises a step of generation of scanning signals, called initial signals, and a step of correction of said initial signals into signals, called corrected signals, suitable for provoking a deflection of said light beam so as to form the output image of said image generation device.

Advantageously, said corrected signals are determined from said initial signals and predetermined correction functions.

Advantageously, said predetermined correction functions are functions for approximating optical laws of distortion of an image by said optical system.

Advantageously, the step of generation of initial scanning signals comprises:
a step of extraction of horizontal and vertical synchronization signals,
a step of generation of an initial horizontal scanning signal,
a step of generation of an initial vertical scanning signal.

Advantageously, the step of correction of said initial signals into said corrected signals comprises a step of generation of a modulation, notably of amplitude, of the horizontal scanning signal, that is a function of a vertical position in said image, synchronized by said vertical synchronization signal to supply said corrected horizontal scanning signal.

Advantageously, the step of correction of said initial signals into said corrected signals comprises a step of generation of a modulation, notably of amplitude, of the vertical scanning signal, that is a function of a horizontal position in said image, synchronized by said horizontal synchronization signal, to supply said corrected vertical scanning signal.

Advantageously, said method comprises a step of storage of said correction functions in a parameterizable non-volatile memory.

Other aims, features and advantages of the invention will become apparent on reading the following description given in a purely nonlimiting manner and which refers to the attached figures in which:

FIG. 1 is a schematic view of a head-up display and of a control system according to the prior art,

FIG. 2 is a schematic view of a head-up display and of a control system according to a the invention,

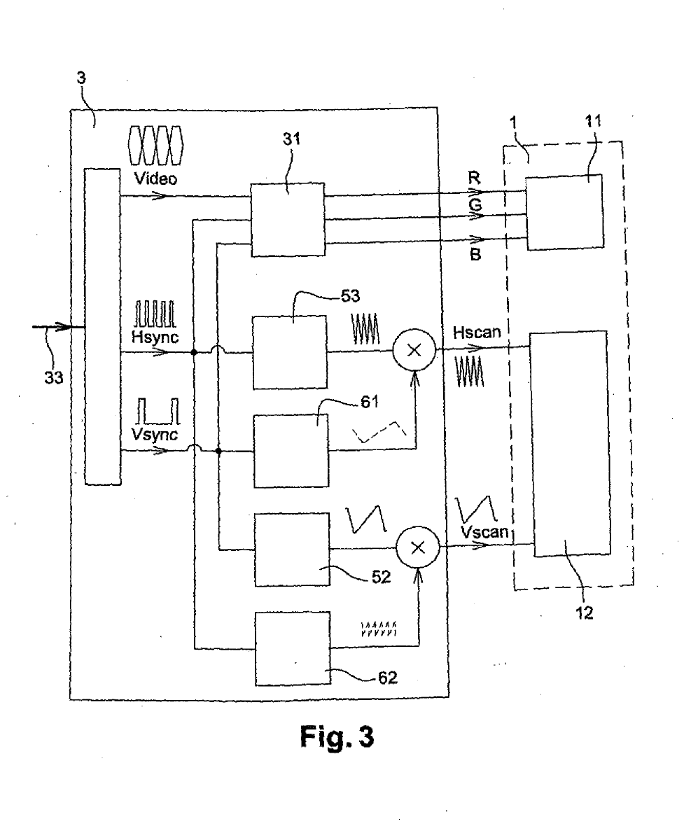

FIG. 3 is a functional block diagram view of an exemplary embodiment of the control system according to the invention.

As illustrated in FIG. 2, the invention relates to a display, notably a head-up display, in particular for a motor vehicle.

As already mentioned above in relation to the prior art, said display comprises an image generation device 1, intended to form, from a light beam, an image 105 to be transmitted by an optical system, to form an image 106. Said optical system here comprises a windshield 22 of the vehicle, said image 106 formed by the display being positioned beyond the windshield. Said display further comprises a control system 3 for said image generation device 1.

Said image generation device 1 comprises a light source 11, generating said light beam, a scanning generator 2 and a projection screen-forming surface 13. Said scanning generator allows said beam to scan said surface 13 so as to form the images projected by said display. Said control system 3 drives said scanning generator 2. The image to be projected 101 corresponds to a so-called initial video signal.

According to the invention, said image generation device 1 here comprises a light source 11 generating said beam. It is advantageously a source of laser type. Said source 11 will be able to comprise a plurality of laser diodes, notably three, said source being configured to form the light beam, intended to be deflected by the scanning generator 2, by juxtaposition of the beams individually emitted by each of said diodes. Said diodes each emit a different color, for example, a red, a green or a blue (RGB). Said light source 11 is advantageously driven by said control system 3 which determines the light power emitted by each diode. In this way it is possible to determine the light intensity and/or the color of each pixel of the image.

The function of said scanning generator 2 is, here, to horizontally and vertically displace the light beam in order to produce a scan according to a predetermined frequency of the surface 13 to form the image 105.

Said scanning generator comprises, for example, a scanning mirror 14 driven by an actuator 12 which receives the control signals supplied by the control system 3 according to the invention. This mirror is, for example, a mirror with micro-electro-mechanical system (also known as “MEMS mirror”) on which the light beam is reflected in a scanning beam. Such a mirror is able to rotate about two axes of rotation to perform a scan, the actuator driving the control signal for each of the axes. Alternatively, the MEMS mirror can be replaced by two flat and displaceable mirrors, the movements of which are associated. One of these mirrors can be dedicated to a scan on a horizontal axis while the other mirror can be dedicated to a scan on a vertical axis.

Advantageously, said projection screen 13 is a diffuser. It is, notably, a transparent screen with complex structure for a projection by transparency. It will, alternatively, be able to be translucent. It is produced, for example, in glass, notably depolished, or in polycarbonate. As an example, the diffuser screen 13 is of the type with exit pupil (“exit pupil expander”). It makes it possible to have a widened observation cone. It extends in a plane crossed by the light beam, the image 105 resulting from the scanning beam being formed in the plane of a face of the diffuser screen 13.

In other words, the diffuser screen receives the scanning beam and it is arranged to provoke a scattering of this scanning beam according to an angular segment, for example, equal to 5° relative to the direction of the scanning beam at the moment when it strikes the diffuser screen 13. For this, according to a nonlimiting example, one face of the diffuser screen is rough, in as much as it includes unevennesses which provoke the scattering of the scanning beam. The rough face corresponds to that by which the beam exits from the image generation device, that is to say the face on which the image 105 is formed.

Said control system 3 comprises a unit 32 for generating scanning signals 45, 46, intended to provoke a deflection of said beam so as to form an image at the output of said image generation device 3. Said scanning signal generation unit 32 is here configured to deliver, in a synchronized manner, a horizontal scanning signal 45 and a vertical scanning signal 46. Said control system 3 here further comprises a unit 31 for driving the lighting of said laser diodes. Said units 31, 32 are synchronized.

According to the invention, in order to mitigate the deformation imparted by the optical system, in particular the windshield 22, said system is configured for said scanning signals to include a correction component, here symbolically introduced by the functional block 41, allowing said image 105 to exhibit a deformation that is the reverse of that produced by said optical system. Thus, the image 106 projected by the display appears non-deformed.

As described later, said scanning signal generation unit comprises, for example, a module for generating scanning signals, called initial signals, from an input signal 33, and a module for correcting said initial signals into signals, called corrected signals, suitable for provoking a deflection of said light beam so as to form an image, called compensated image, at the output of said image generation device. Said compensated image corresponds to the image 105 exhibiting the deformation that is the reverse of that produced by said optical system.

Said corrected signals are determined, for example, from said initial signals and predetermined correction functions.

The correction functions can, in the general case, be expressed in the form:
for the horizontal scan: X=fX(x,y)
for the vertical scan: Y=fY(x,y),
(x,y) being the coordinates of the initial image 101 and (X, Y) being the coordinates of the compensated image 105.

The correction functions fX and fY can be obtained by reversing, by formal computation, the optical laws of distortion of the deformed image as it would be displayed, without compensation. They will also be able to be obtained by approximation of said optical laws of distortion. It should be noted that, by virtue of the invention, said functions are independent of the content of the image.

As illustrated in FIG. 3, said initial signal generation module will be able to comprise a module 51 for extracting vertical and horizontal synchronization signals from the input signal 33. Said extraction unit 51 also supplies, from said input signal 33, a video signal transmitted to said driving unit 31. It further comprises a module 52 for generating an initial vertical scanning signal and a module 53 for generating an initial horizontal scanning signal, configured to use, respectively, the vertical and horizontal synchronization signals.

Said module for correcting the scanning signals comprises, for example, a module 61 for generating a modulation of the initial horizontal scanning signal. Said initial signal is more specifically modulated as a function of a vertical position in said image synchronized by said vertical synchronization signal to supply a corrected horizontal scanning signal. It will be able to be, for example, an amplitude modulation.

Said module for correcting the scanning signals further comprises a module 62 for generating a modulation of the initial vertical scanning signal. Said initial signal is more specifically modulated as a function of a horizontal position in said image synchronized by said horizontal synchronization signal to supply a corrected vertical scanning signal. It will be able to be, for example, an amplitude modulation.

Said synchronization signals are, here, also delivered to said driving unit 31.

As an example it will be possible to obtain the desired compensation effect by speeding up the horizontal scanning for certain values of the vertical scan. Typically, in the case illustrated, the scanning speed is increased in the bottom part of the image which gives it its trapezoidal form.

Moreover, the correction functions will be able to be stored in the form of tables or of formulae parameterized in a nonvolatile memory which makes it possible to configure the same system for different vehicles or adapt the control system to a change of windshield by selecting the appropriate parameters.

1. A control system for a device for generating scanned images for a head-up display, intended to form, from a light beam, an image to be transmitted by an optical system, said control system comprising;
a unit for generating scanning signals, intended to provoke a deflection of said beam so as to form said image, called output image of said image generation device,
wherein said scanning signals include a correction component allowing said output image of said image generation device to exhibit a deformation that is the reverse of that produced by said optical system.

2. The system as claimed in claim 1, in which said scanning signal generation unit comprises a module for generating scanning signals, called initial signals, and a module for correcting said initial signals into signals, called corrected signals, suitable for provoking a deflection of said light beam so as to form said output image of said image generation device.

3. The control system as claimed in claim 2, wherein said corrected signals are determined from said initial signals and predetermined correction functions.

4. The control system as claimed in claim 3, further comprising a parameterizable non-volatile memory in which said correction functions are stored.

5. The control system as claimed in claim 3, wherein said predetermined correction functions are functions for approximating optical laws of distortion of an image by said optical system to which said image generation device is intended to be linked.

6. The control system as claimed in claim 2, wherein said module for generating initial signals comprises:
a module for extracting vertical and horizontal synchronization signals,
a module for generating an initial horizontal scanning signal, and
a module for generating an initial vertical scanning signal.

7. The control system as claimed in claim 6, wherein said module for correcting the scanning signals comprises a module for generating a modulation of the initial horizontal scanning signal that is a function of a vertical position in said image, synchronized by said vertical synchronization signal to supply a corrected horizontal scanning signal.

8. The control system as claimed in claim 6, wherein said module for correcting the scanning signals comprises a module for generating a modulation of the initial vertical scanning signal, that is a function of a horizontal position in said image, synchronized by said horizontal synchronization signal to supply a corrected vertical scanning signal.

9. An image generation device comprising a control system as claimed in claim 1.

10. The device as claimed in claim 9, comprising a scanning generator allowing said beam to scan a projection screen-forming surface of said device, said control system driving said scanning generator.

11. The device as claimed in claim 10, in which said projection screen is a diffuser.

12. The device as claimed in claim 9, comprising a light source generating said beam.

13. The device as claimed in claim 12, in which said light source is of the laser type.

14. The device as claimed in claim 12, in which said light source is driven by said control system.

15. A head-up display, comprising an image generation device as claimed in claim 9.

16. A control method for a device for generating scanned images intended to form, from a light beam, an image to be transmitted by an optical system, said method comprising:
a step of generation of scanning signals, intended to provoke a deflection of said beam so as to form said image, called output image of said image generation device, said scanning signals including a correction component allowing said output image of said image generation device to exhibit a deformation that is the reverse of that produced by said optical system.

17. The method as claimed in claim 16, in which said scanning signal generation step comprises a step of generation of scanning signals, called initial signals, and a step of correction of said initial signals into signals, called corrected signals, suitable for provoking a deflection of said light beam so as to form said output image of said image generation device.

18. The method as claimed in claim 17, wherein said corrected signals are determined from said initial signals and predetermined correction functions.

19. The method as claimed in claim 18, further comprising a step of storage of said correction functions in a parameterizable non-volatile memory.

20. The method as claimed in claim 18, wherein said predetermined correction functions are functions for approximating optical laws of distortion of an image by said optical system.

21. The method as claimed in claim 17, wherein said step of generation of initial scanning signals comprises:
a step of extraction of horizontal and vertical synchronization signals,
a step of generation of an initial horizontal scanning signal, and
a step of generation of an initial vertical scanning signal.

22. The method as claimed in claim 21, wherein said step of correction of said initial signals into said corrected signals comprises a step of generation of a modulation of the horizontal scanning signal, that is a function of a vertical position in said image, synchronized by said vertical synchronization signal to supply said corrected horizontal scanning signal.

23. The method as claimed in claim 21, wherein said step of correction of said initial signals into said corrected signals comprises a step of generation of a modulation of the vertical scanning signal, that is a function of a horizontal position in said image, synchronized by said horizontal synchronization signal, to supply said corrected vertical scanning signal.
